(19) United States
(12) Patent Application Publication
(10) Pub. No.: US 2008/0179393 A1
(43) Pub. Date: Jul. 31, 2008

(54) METHOD AND SYSTEM USING PORTABLE CONSUMER DEVICE INCLUDING PAYMENT CAPABILITY

(76) Inventor: Nizam Antoo, San Carlos, CA (US)

Correspondence Address: TOWNSEND AND TOWNSEND CREW LLP, TWO EMBARCADERO CENTER, 8TH FLOOR, SAN FRANCISCO, CA, 94111, US

(21) Appl. No.: 11/668,918

(22) Filed: Jan. 30, 2007

(51) Int. Cl. G06K 5/00

(52) U.S. Cl. 235/380

(57) ABSTRACT

A method for receiving cash from a merchant is disclosed. The method includes interacting with an access device at a merchant in a transaction using a portable consumer device. The portable consumer device is associated with a monetary value that represents wages earned by an employee. After interacting, the access device sends an authorization request message to an issuer of the portable consumer device. The issuer thereafter sends an authorization response message back to the merchant indicating approval of the transaction. The employee then receives cash from the merchant that is substantially equal to the monetary value associated with the portable consumer device.

### CROSS-REFERENCES TO RELATED APPLICATIONS

NOT APPLICABLE

### BACKGROUND

Embodiments of the invention relate to payroll cards. There are millions of employees who do not have checking accounts at banks. They receive money in the form of payroll checks. To cash those payroll checks, they must typically go to check cashing services where they are charged fees to cash them. This is a particularly time consuming and burdensome process for the employees.

Payroll checks have other disadvantages. Paper payroll checks are can be relatively costly and burdensome to process in comparison to electronic forms of payment. Keeping records with paper payroll checks is also more difficult than using electronic forms of payment. Paper payroll checks use more manual processing than electronic forms of payment.

Payroll cards were developed to address the problem of payroll checks. Instead of receiving a payroll check, an employee could receive a payroll card. The payroll card could be provided by an employer to an employee. The employee could then go to a bank or an ATM to withdraw funds. The employee could also use the payroll card to pay bills or make purchases.

Although the payroll card solution is effective, a number of improvements could be made. For example, employees who receive payroll cards instead of payroll checks may want to redeem their cards for the entire monetary amounts associated with their cards (i.e., “cash out” their cards). While payroll cards can be cashed out at banks to do this, employees who do not have checking accounts typically do not use banks. ATMs also cannot be used to do this. Only a certain amount of money may be withdrawn from an ATM at a given time. This prevents an employee from obtaining cash in an amount equal to the entire monetary value of his payroll card. For example, there may be a $300 limit on ATM disbursements per day, or the ATM may only dispense money in increments of $20 bills. If the employee receives a payroll card with $1000 on it, and that employee wants all of the money in cash that day, then an ATM cannot be used. Also, some state labor laws require employers to pay their employees in a way that will allow employees to obtain their wages earned free and clear without a fee. This inhibits many employers from dispensing payroll cards instead of payroll checks, since there are limited ways in which an employee may receive all or substantially all of the monetary value associated with a payroll card that is provided to that employee.

Embodiments of the invention address these and other problems, individually and collectively.

### BRIEF SUMMARY

Embodiments of the invention are directed to methods, computer readable media, and systems that can provide cash to an employee or other entity that receives a portable consumer device that has a monetary value. The monetary value may be derived from a payment made to a person such as an employee. In preferred embodiments, the portable consumer device is a payroll card.

One embodiment of the invention includes interacting with an access device at a merchant in a transaction using a portable consumer device. The portable consumer device may be associated with a monetary value that represents a payment made to a person such as an employee or benefit recipient. After interacting, the access device sends an authorization request message to an issuer of the portable consumer device. The issuer thereafter sends an authorization response message back to the merchant indicating approval of the transaction. The person then receives cash from the merchant that is substantially equal to the monetary value associated with the portable consumer device.

Another embodiment of the invention is directed to a method comprising interacting with a portable consumer device with an access device at a merchant in a transaction, wherein the portable consumer device is associated with a monetary value that represents a payment made to a person. After interacting, the access device sends an authorization request message to an issuer of the portable consumer device. The authorization response message is received indicating approval of the transaction from the issuer. The merchant subsequently provides cash to the person in an amount substantially equal to the monetary value.

Another embodiment of the invention is directed to a method comprising receiving an authorization request message. The authorization request message is generated in response to an interaction with an access device at a merchant in a transaction using a portable consumer device. The portable consumer device is associated with a monetary value that represents a payment made to a person. An authorization response message is sent back to the merchant indicating approval or disapproval of the transaction. If the transaction is approved, the merchant provides cash to the person in an amount substantially equal to the monetary value.

Another embodiment of the invention is directed to a method comprising interacting with a portable consumer device with an access device at a merchant in a transaction. The portable consumer device is associated with a monetary value that represents a payment made to a person. After interacting, the access device sends an authorization request message to an issuer of the portable consumer device. An authorization response message is received indicating approval of the transaction from the issuer. The merchant subsequently provides cash to the person, and a fee is received from the issuer for participating in the transaction.

Another embodiment of the invention is directed to a method comprising interacting with a portable consumer device with an access device at a merchant in a transaction. The portable consumer device is associated with a monetary value that represents a payment made to a person. After interacting, the access device sends an authorization request message to an issuer of the portable consumer device. An authorization response message is received indicating approval of the transaction from the issuer. The merchant subsequently provides cash to the person, and receives a fee for participating in the transaction.

Another embodiment of the invention is directed to a method comprising receiving an authorization request message, wherein the authorization request message is generated in response to an interaction with an access device at a merchant in a transaction using a portable consumer device. The portable consumer device is associated with a monetary value that represents a payment to a person. An authorization response message is sent back to the merchant indicating approval or disapproval of the transaction. If the transaction is approved, the merchant provides cash to the person. A fee is provided to the merchant or an acquirer that is associated with the merchant for participating in the transaction.

These and other embodiments of the invention are described in further detail below.

### BRIEF DESCRIPTION OF THE FIGURES

FIG. 1 shows a block diagram of a system according to an embodiment of the invention.

FIG. 2 shows a flowchart illustrating a method according to an embodiment of the invention.

### DETAILED DESCRIPTION

Embodiments of the invention solve the above-noted problems by allowing merchants to provide cash to employees who want to redeem their portable consumer devices. Merchants are everywhere and are easily accessible to the employees. In addition, employees without bank accounts are used to shopping at merchants, so they would not be inhibited or uncomfortable going to merchants to obtain cash using their portable consumer devices.

To encourage participation, participating merchants and their acquirers can be paid a fee (e.g., 1%) for allowing employees to redeem some or all of the monetary value associated with their portable consumer devices for cash. The fees may come from the issuers of the portable consumer devices. This process can be characterized as sort of a “reverse interchange” process, because it is different than a normal interchange process where merchants pay issuers when portable consumer devices such as credit cards are used.

Although the specific examples that are described above and below relate to payments made by an employer to an employee, in other embodiments, the payments could be made from a governmental entity such as a state or local government to a benefit recipient (e.g., a social security benefit recipient for social security payments, a disability benefit recipient for disability payments), insurers to their insured individuals (e.g., reimbursement payments to insured individuals for insurance claims), etc. Embodiments of the invention may encompass any suitable situation where one entity is paying another entity using a portable consumer device, and wherein the receiving entity wants to redeem all or substantially all of the monetary value of the portable consumer device at a merchant.

A number of entities may benefit from embodiments of the invention. Such entities may include issuers, merchants, employers, and employees.

The benefit to an issuer of portable consumer devices would be in greater potential use of such portable consumer devices. For example, by encouraging the use of portable consumer devices with payroll capability, employees using such portable consumer devices would pay for more goods or services using them. For example, payroll cards could be used like stored value cards. If the employees use payroll cards to buy goods or services from merchants, the issuers of the payroll cards would receive fees from the merchants, as they would for traditional debit and credit card transactions. Also, issuers also benefit from decreased processing costs, relative to check processing costs.

The benefit to a merchant is that it can be paid for the transaction by the issuer. Also, an employee who regularly redeems his portable consumer device at a particular merchant is likely buy goods or services from that merchant. The end result is that the merchant would likely experience higher sales of its goods and services, due to increased usage of portable consumer devices.

The benefit to an employer is that portable consumer devices such as payroll cards are less expensive to issue than paper checks. Also, the management (including reconciliation) of the employer's payroll using portable consumer devices is easier than using checks, since all payments are in electronic form. Some employers may employ thousands of employees across the country, and providing paper checks to each and every one of them can be expensive and difficult. In addition, embodiments of the invention satisfy state labor laws, since employees can redeem their portable consumer devices for cash without paying fees to get that cash.

The benefit to the employee is that portable consumer devices are more convenient to use than paper checks. An employee can choose to use a portable consumer device like a stored value card, or may choose to redeem the entire monetary value associated with the portable consumer device.

There are a number of useful features that are present in embodiments of the invention, and they may be used separately or in combination. They include (1) a stand alone transaction whereby the transaction allows an employee (or other persons) to redeem substantially all of the monetary value associated with a portable consumer device for cash; and (2) a reverse interchange process whereby payment is made from the issuer to the acquirer and/or the merchant in exchange for the merchant's service of allowing employees (or other persons) to redeem their portable consumer devices for cash.

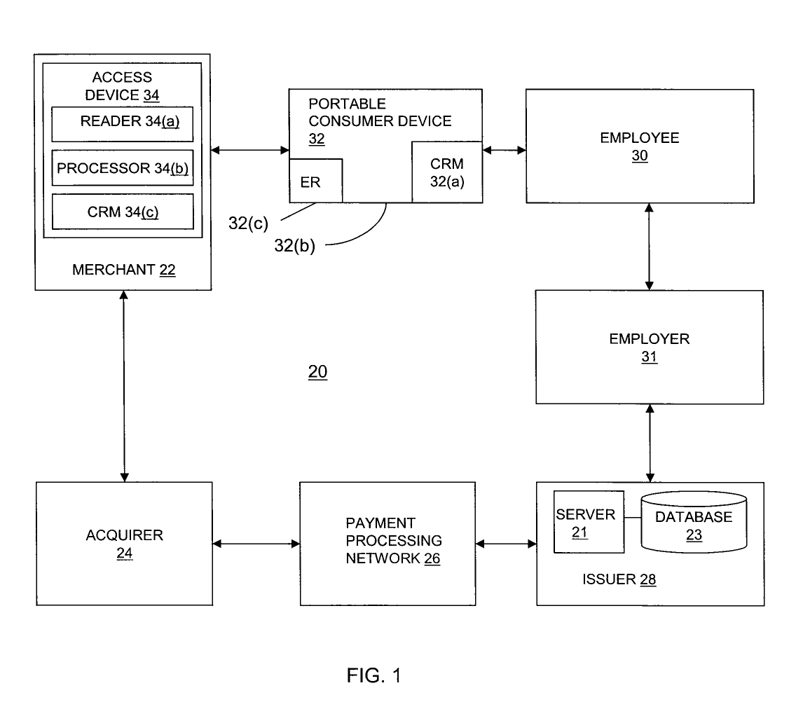

FIG. 1 shows a system 20 that can be used in an embodiment of the invention. The system 20 shown in FIG. 1 illustrates one merchant, one acquirer, one employee, one employer, one portable consumer device, one issuer, and one payment processing network for simplicity of illustration. It is understood that embodiments of the invention may have more or less components than are shown in FIG. 1.

The system 20 includes a merchant 22 and an acquirer 24 associated with the merchant 22. The merchant 22 may have an account at the acquirer 24, and therefore may be affiliated with the acquirer 24. An issuer 28 may be in operative communication with the acquirer 24 via a payment processing network 26. An employer 31 may also be in operative communication with the issuer 28. The employer 31 may also give the employee 30 a portable consumer device, issued by the issuer 32 in exchange for work performed, or may provide the portable consumer device 32 with additional value if the portable consumer device 32 is in the form of a reloadable card, cell phone, key fob, etc.

The acquirer 24 is typically a bank that has a merchant account. The issuer 28 may also be a bank, but could also be business entity such as a retail store. Some entities are both acquirers and issuers, and embodiments of the invention include such entities. The employer 30 may have an account with the issuer 28 and the merchant 22 may have an account at the acquirer 24.

The issuer 28 may have or operate a server computer 21 and a database 23. As used herein, a “server computer” is typically a powerful computer or cluster of computers. For example, the server computer can be a large mainframe, a minicomputer cluster, or a group of servers functioning as a unit. In one example, the server computer may be a database server coupled to a Web server. A server computer services the requests of one or more client computers. The database 23 may contain employer account information, portable consumer device identification data, pin data, and account data, and other information.

The monetary values associated with the portable consumer devices may be stored in the database 23, and the portable consumer devices may or may not store data representing the monetary values associated with the portable consumer devices. For example, the portable consumer device 32 may simply comprise an identification number (e.g., an account number). This account number may be stored in the database 23 with the monetary value (e.g., $500) associated with the portable consumer device 32. In this example, data representing the monetary value (e.g., $500) would not be stored on the portable consumer device 32. In other embodiments, data representing the monetary value associated with the portable consumer device 32 could be stored in a computer readable medium 32(a) of the portable consumer device 32.

The employee 30 may work for the employer 31 and may get paid by the employer 31. As used herein, “employee” may include traditional employees of employers as well as independent contractors or others who might be paid for work performed using a portable consumer device instead of a check.

The portable consumer device 32 may be in any suitable form. For example, suitable portable consumer devices can be hand-held and compact so that they can fit into a consumer's wallet and/or pocket (e.g., pocket-sized). They may include smart cards, magnetic stripe cards, keychain devices (such as the Speedpass™ commercially available from Exxon-Mobil Corp.), etc. Other examples of portable consumer devices include cellular phones, personal digital assistants (PDAs), pagers, payment cards, security cards, access cards, smart media, transponders, and the like.

The portable consumer device 32 may comprise a computer readable medium 32(a) and a body 32(b). The computer readable medium 32(a) may be on the body 32(b). The body 32(b) may in the form a plastic substrate, housing, or other structure. The computer readable medium 32(a) may be a memory that stores data and may be in any suitable form. Exemplary computer readable media 32(a) may be in any suitable form including a magnetic stripe, a memory chip, etc. If the portable consumer device 32 is in the form of a card, it may have an embossed region ER 32(c) which is embossed with a PAN (primary account number). The computer readable medium 32(a) may electronically store the PAN as well as other data such as PIN data.

The payment processing network 26 may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™, in particular, includes a VIP system (Visa Integrated Payments system) which processes authorization requests and a Base II system which performs clearing and settlement services. The payment processing network 26 may use any suitable wired or wireless network, including the Internet.

The merchant 22 may also have, or may receive communications from, an access device 34 that can interact with the portable consumer device 32. In FIG. 1, the access device 34 is located at the merchant 22. However, it could be located at any other suitable location in other embodiments of the invention. Suitable merchants may include department stores, gas stations, drug stores, grocery stores, etc.

The access devices according to embodiments of the invention can be in any suitable form. Examples of access devices include point of sale (POS) devices, cellular phones, PDAs, personal computers (PCs), tablet PCs, handheld specialized readers, set-top boxes, electronic cash registers (ECRs), automated teller machines (ATMs), virtual cash registers (VCRs), kiosks, security systems, access systems, and the like. Such access devices may send or receive data from the portable consumer device 32 using any suitable contact or contactless mode of operation.

If the access device 34 is a point of sale terminal, any suitable point of sale terminal may include a reader 34(a), a processor 34(b) and a computer readable medium 34(c). The reader 34(b) may include any suitable contact or contactless mode of operation. For example, exemplary card readers can include RF (radio frequency) antennas, magnetic stripe readers, etc. to interact with the portable consumer device 32.

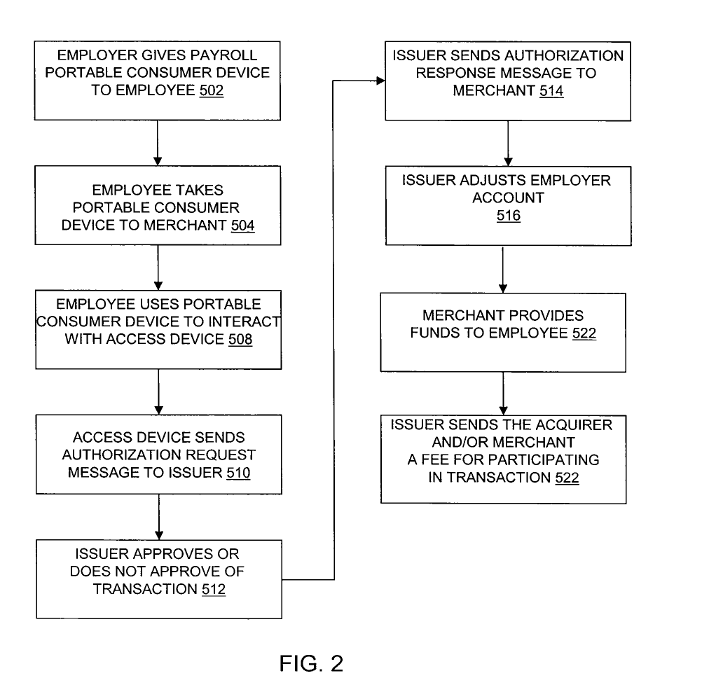

Some embodiments of the invention can be described with reference the flowchart in FIG. 2 and the system in FIG. 1.

As shown in FIG. 2, an employer 31 provides the employee 30 with a portable consumer device 32 as a form of compensation for work performed (step 502). The portable consumer device 32 may have been created by the issuer 28 or provisioned by the issuer 28. For example, the issuer 28 may issue portable consumer devices to the employer's employees on behalf of the employer 31. They could be provided directly to the employee 30 from the issuer 28, from the employer 31, or from a third party operating on behalf of the employer 31. A separate wage statement may also be sent from the employer 31 to the employee 30. It may include information such as tax information, benefits and/or salary accrued to date, etc.

Once the employee 30 obtains the portable consumer device 32, the employee 30 may decide that he wants to redeem the entire monetary value associated with the portable consumer device 32 for cash. The consumer then takes the portable consumer device 32 to the merchant 22 (step 504).

At the merchant 22, the employee 30 uses the portable consumer device 32 to interact with the access device 34 at the merchant 22 (step 508). The employee 30 may also be requested by the access device 34 to provide a PIN (personal identification number) or other identifier to verify that the employee 30 is authorized to make purchases with the portable consumer device 32, or redeem some or all of the monetary value associated with the portable consumer device 32 for cash. Some form of ID (e.g., a driver's license) may also be required by the merchant 22 before it proceeds with the transaction. Accordingly, at the merchant 22, the employee 30 may purchase goods or services using the portable consumer device 32, and may additionally or alternatively obtain funds (e.g., cash) substantially equal (e.g., equal to) to the monetary value associated with the portable consumer device 32. The employee 30 need not buy anything at the merchant 22.

The monetary value associated with the portable consumer device 32 may represent a payment (e.g., wages) made to the employee 30 working on behalf of the employer 31. For example, the monetary value associated with the portable consumer device 32 may represent the net pay that the employee 30 would receive for a predetermined amount of work (e.g., payment for a project, or payment for one week, two weeks, or one months worth of work).

The monetary value associated with the portable consumer device 32 could alternatively represent other types of recurring payments by other entities. For example, in other embodiments, the employer may alternatively be an entity such as a governmental entity, while the employee may alternatively be entities such as benefit recipients such as social security recipients, child support payments or unemployment insurance, etc.

After the employee 30 uses the portable consumer device 32 to interact with the access device 34, the access device 34 then sends an authorization request message to the issuer 510 via the acquirer 34 and the payment processing network 26 (step 510). The authorization request message may include the account number associated with the card, the amount of money sought by the employee 30, a merchant identifier (e.g., a merchant category code), and an encrypted identifier for the employee 30 such as a PIN.

After the authorization request message is received at the server computer 21 operated by the issuer 28, the issuer 28 either approves or does not approve of the transaction (step 512). The issuer 28 checks to see if there are sufficient funds in the employee's portable device 28. The issuer 28 may also authenticate the employee 30 by decrypting the PIN that was sent in the authorization request message.

After the issuer 28 receives the authorization request message, the issuer 28 then sends an authorization response message to the merchant 22 (step 514) indicating whether or not the transaction is approved. If it is approved, then the issuer 28 debits the employee's portable consumer device (step 516). If it is not approved, then the authorization response message indicates that the transaction is declined and an appropriate message is provided to the employee 30 via the access device 34.

The employer 31 may have an account for the portable consumer device 32 and for the employee 30 with the issuer 28. The employer 31 would not be allowed to withdraw funds from that account, since the account would be funded with wages earned by the employee 30. Withdrawing funds from that account can be characterized as debiting the portable consumer device 32.

After the authorization response message is received by the merchant 22, and if the authorization response message indicates that the issuer 28 approves of the transaction, then the merchant 22 may provide funds (e.g., give cash) to the employee 30 (step 522). The amount of the funds provided may be substantially equal to the monetary value associated with the portable consumer device 32. For example, if the portable consumer device 32 is associated with $1000 for wages earned during a predetermined time period (e.g., 1 week), then the employee 30 would receive $1000 in cash from the merchant 22. The employee 30 would not be charged a fee for this transaction by the merchant 22 in preferred embodiments. In this embodiment, the monetary value associated with the portable consumer device 32 may be substantially equal to the employee's paycheck (e.g., a check for work performed during a predetermined amount of time such as a month, bi-week, or week).

The monetary amount associated with the portable consumer device 32 may also be determined after the employee 30 makes purchases at the merchant 22. For example, an employee 30 may be given a portable consumer device 32 with $2000 on it for work performed for the employer 31 during a two week period. The employee 30 may purchase a television at the merchant 22 for $500, and the monetary value associated with the portable consumer device 32 would then be $1500. The employee 30 may thereafter obtain the remaining $1500 from the merchant 22 in cash. In embodiments of the invention, the amount of cash received by the employee 30 can be $500 or more, and can be greater than the amount of cash that can be provided by a typical ATM machine.

After or during the transaction, the issuer 28 may then provide a fee to either or both of the acquirer 24 and/or the merchant 22 (e.g., via an account with the acquirer 24) for participating in the transaction (step 522). The amount of any fees provided may be determined by the parties involved. In some cases, the fees may be less than about 5, 2, or 1 percent of the values of the transactions conducted.

In the above-described embodiments, “real time authorization and real time settlement” may occur as opposed to a delayed settlement process that may occur with a conventional credit card transaction. In embodiments of the invention, the funds get moved almost immediately (i.e., money gets paid to the employee and the employer's account gets debited). Embodiments of the invention may also be characterized as a single message transaction so that processing is fast and efficient.

It should be understood that the present invention as described above can be implemented in the form of control logic using computer software in a modular or integrated manner. Based on the disclosure and teachings provided herein, a person of ordinary skill in the art will know and appreciate other ways and/or methods to implement the present invention using hardware and a combination of hardware and software

Any of the software components or functions described in this application, may be implemented as software code to be executed by a processor using any suitable computer language such as, for example, Java, C++ or Perl using, for example, conventional or object-oriented techniques. The software code may be stored as a series of instructions, or commands on a computer readable medium, such as a random access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

1. A method comprising:
interacting with an access device at a merchant in a transaction using a portable consumer device, wherein the portable consumer device is associated with a monetary value that represents a payment made to a person, and wherein after interacting, the access device sends an authorization request message to an issuer of the portable consumer device, and the issuer thereafter sends an authorization response message back to the merchant indicating approval of the transaction; and
receiving an amount of cash from the merchant that is substantially equal to the monetary value.

2. The method of claim 1 wherein receiving cash from the merchant that is substantially equal to the monetary value includes receiving cash from the merchant that is equal to the monetary value.

3. The method of claim 1 wherein the portable consumer device is in the form of a card, and wherein the person is a benefit recipient or an employee.

4. The method of claim 1 further comprising:
receiving the portable consumer device.

5. The method of claim 1 wherein the monetary value is equal to an amount equal to wages earned by the person during a predetermined period of time.

6. The method of claim 1 wherein the monetary value associated with the portable consumer device is an amount that is obtained after the person uses the portable consumer device to purchase goods or services at the merchant.

7. A method comprising:
interacting with a portable consumer device with an access device at a merchant in a transaction, wherein the portable consumer device is associated with a monetary value that represents a payment made to a person, and wherein after interacting, the access device sends an authorization request message to an issuer of the portable consumer device; and
receiving an authorization response message indicating approval of the transaction from the issuer, and wherein the merchant subsequently provides cash to the person in an amount substantially equal to the monetary value.

8. The method of claim 7 wherein the portable consumer device is in the form of a card.

9. A computer readable medium comprising code for performing the method of claim 7.

10. A point of sale terminal comprising the computer readable medium of claim 9.

11. A method comprising:
receiving an authorization request message, wherein the authorization request message is generated in response to an interaction with an access device at a merchant in a transaction using a portable consumer device, wherein the portable consumer device is associated with a monetary value that represents a payment made to a person; and
sending an authorization response message back to the merchant indicating approval or disapproval of the transaction, and wherein if the transaction is approved, the merchant provides an amount of cash to the person in an amount substantially equal to the monetary value.

12. The method of claim 11 wherein the portable consumer device is in the form of a card, and wherein the person is an employee and the payment is for work performed by the employee.

13. The method of claim 11 further comprising paying a fee to an acquirer associated with the merchant for participating in the transaction.

14. The method claim 11 further comprising paying a fee to the merchant for participating in the transaction.

15. A computer readable medium comprising code for performing the method of claim 11.

16. A server computer comprising the computer readable medium of claim 15.

17. A method comprising:
interacting with a portable consumer device with an access device at a merchant in a transaction, wherein the portable consumer device is associated with a monetary value that represents a payment made to a person, and wherein after interacting, the access device sends an authorization request message to an issuer of the portable consumer device; and
receiving an authorization response message indicating approval of the transaction from the issuer, and wherein the merchant subsequently provides cash to the person; and
receiving a fee for participating in the transaction.

18. The method of claim 17 wherein the portable consumer device is a payroll card, and wherein the fee is received from the issuer.

19. The method of claim 17 wherein the cash that is provided to the person is substantially equal to the monetary value.

20. A computer readable medium comprising code for performing the method of claim 17.

21. A method comprising:
receiving an authorization request message, wherein the authorization request message is generated in response to an interaction with an access device at a merchant in a transaction using a portable consumer device, wherein the portable consumer device is associated with a monetary value that represents a payment made to a person;
sending an authorization response message back to the merchant indicating approval or disapproval of the transaction, and wherein if the transaction is approved, the merchant provides cash to the employee; and
providing a fee to the merchant or an acquirer that is associated with the merchant for participating in the transaction.

22. The method of claim 21 wherein the portable consumer device is a payroll card.

23. The method of claim 21 wherein the monetary value associated with the portable consumer device is an amount that is obtained after the person uses the portable consumer device to purchase goods or services at the merchant.

24. A computer readable medium comprising computer code for performing the method of claim 21.

25. A server computer comprising the computer readable medium of claim 24.

26. A system comprising:
the server computer of claim 25; and
the access device in operative communication with the server computer.

27. A system comprising:
means for receiving an authorization request message, wherein the authorization request message is generated in response to an interaction with an access device at a merchant in a transaction using a portable consumer device, wherein the portable consumer device is associated with a monetary value that represents a payment made to a person; and
means for sending an authorization response message back to the merchant indicating approval or disapproval of the transaction, and wherein if the transaction is approved, the merchant provides an amount of cash to the person in an amount substantially equal to the monetary value.

28. A system comprising:
means for interacting with a portable consumer device with an access device at a merchant in a transaction, wherein the portable consumer device is associated with a monetary value that represents a payment made to a person, and wherein after interacting, the access device sends an authorization request message to an issuer of the portable consumer device; and
means for receiving an authorization response message indicating approval of the transaction from the issuer, and wherein the merchant subsequently provides cash to the person; and
means for receiving a fee for participating in the transaction.

29. A system comprising:
means for interacting with a portable consumer device with an access device at a merchant in a transaction, wherein the portable consumer device is associated with a monetary value that represents a payment made to a person, and wherein after interacting, the access device sends an authorization request message to an issuer of the portable consumer device; and
means for receiving an authorization response message indicating approval of the transaction from the issuer, and wherein the merchant subsequently provides cash to the person in an amount substantially equal to the monetary value.
